(19) United States
(12) Patent Application Publication
(10) Pub. No.: US 2017/0316618 A1
(43) Pub. Date: Nov. 2, 2017

(54) APPARATUS AND METHOD FOR PRESENTING STRUCTURE INFORMATION ABOUT A TECHNICAL OBJECT

(71) Applicant: Siemens Aktiengesellschaft, München (DE)

(72) Inventor: Hermann Georg Mayer, Prien am Chiemsee (DE)

(73) Assignee: Siemens Aktiengesellschaft, Munchen (DE)

(21) Appl. No.: 15/523,506

(22) PCT Filed: Oct. 22, 2015
(86) PCT No.: PCT/EP2015/074440

§ 371 Date: May 1, 2017

(30) Foreign Application Priority Data
Dec. 4, 2014 (DE) 10 2014 224 851.5

(51) Int. Cl. G06T 19/20; G06T 17/10

(52) U.S. Cl. CPC G06T 19/20; G06T 17/10

(57) ABSTRACT

For presenting structure information about a technical object, an apparatus having an identification module for identifying the technical object, a modeling module, an image generation module and having a projection module is provided. The modeling module provides a structure model of the identified technical object and also to specifically ascertain, an outwardly recognizable object structure for the technical object and a piece of inner structure information, associated with the object structure, about the technical object on the basis of the structure model. The image generation module is used to produce a structure image of the technical object, to insert the object structure into the structure image and to insert the structure information into the structure image with the object structure so that it differs from the manner of presentation of the object structure. The projection module is used to project the structure image onto the technical object.

### CROSS-REFERENCE TO RELATED APPLICATIONS

This application claims priority to PCT Application No. PCT/EP2015/074440, having a filing date of Oct. 22, 2015, based off of German application No. DE 102014224851.5, having a filing date of Dec. 4, 2014, the entire contents of which are hereby incorporated by reference.

### FIELD OF TECHNOLOGY

The following relates to an apparatus and method for presenting structure information about a technical object, an apparatus having an identification module for identifying the technical object, a modeling module, an image generation module and having a projection module is provided.

### BACKGROUND

The structure and design of technical objects, such as vehicles, buildings, machines, devices, circuits and systems, is becoming increasingly complex. An in-depth knowledge of relevant structures of a respective technical object is often indispensable, in particular for maintenance, repair and/or rescue work; e.g. the knowledge of where power lines run in a building or the point at which a deformed door of a car involved in an accident can be pried open. In the case of motor vehicles therefore, it is often recommended to carry a so-called rescue card, on which details of critical components, such as the fuel tank, airbags or pressure cylinder are recorded. In the event of an emergency, emergency services can access this structural data, in order to ensure a rapid and safe rescue operation. However, the extent to which such a rescue card can reproduce complex structural data is limited. It is also inherently impossible to represent dynamic values, such as sensor values relating to the engine temperature or the tank fill level.

### SUMMARY

An aspect relates to specifying an apparatus and a method for presenting structure information about a technical object while allowing a more flexible and understandable presentation.

A computer program product (non-transitory computer readable storage medium having instructions, which when executed by a processor, perform actions) according to embodiments of the invention as disclosed herein. The computer program product includes a computer readable hardware storage device having computer readable program code stored therein, said program code executable by a processor of a computer system to implement a method.

In accordance with embodiments of the invention, to present structure information about a technical object, e.g. a vehicle, a building, an airplane, a machine, a device, a circuit or a system, an apparatus is provided, for example a mobile device such as a smartphone, having an identification module, a modeling module, an image generation module and a projection module. The identification module is in this case used for identifying the technical object. The modeling module is set up to provide a structure model of the identified technical object and also to specifically determine, in each case, an externally recognizable object structure for the technical object and a piece of internal structure information, which is physically associated with the object structure, about the technical object on the basis of the structure model. The image generation module is used to create a structure image of the technical object, for inserting the object structure into the structure image in a manner true to projection and for inserting the structure information into the structure image in a graphical association with the object structure in a mode of presentation that differs from the mode of presentation of the object structure. Finally, the projection module is used for projecting the structure image onto the technical object.

By the projection of the structure image, which also contains internal structure information, onto the technical object it is possible for information to be displayed directly and intuitively to a user of the apparatus according to embodiments of the invention on the technical object itself, such as where a structure that is not externally visible is hidden, or where a starting point for a drilled hole or other technical measure is located. The different mode of presentation of externally recognizable object structure and internal structure information facilitates an alignment of the projection and improves the ability to distinguish between the internal and external structures.

Advantageous embodiments and extensions of the invention are specified in the dependent claims.

According to an advantageous embodiment of the invention, an alignment module may be provided for detecting whether the object structure projected onto the technical object is coextensive with a corresponding surface structure of the technical object.

It is thus possible to detect when the projection is correctly aligned to the technical object and specified actions can be triggered dependent on this.

Furthermore, the modeling module can be set up to determine a projection surface of the technical object on the basis of the structure model. The image generation module can then generate the structure image depending on a shape of the determined projection surface, in such a way that when projected onto the technical object, the projected object structure can be brought into alignment with a corresponding surface structure of the technical object.

The incorporation of the shape of the projection surface normally allows the projected structure image to be rectified in such a way that the object structures to be displayed can be reproduced true to scale, even with curved projection surfaces.

According to an advantageous extension of embodiments of the invention, a receiver module may be provided for receiving status information about a status, which is physically associated with the object structure, of the technical object. The receiver module can be coupled with the technical object by wireless and/or wired means. The image generation module can then be set up for inserting the status information into the structure image in a graphical association with the object structure. The status information can comprise, in particular, sensor data from a sensor of the technical object.

This enables dynamic variables, such as temperature, pressure, etc., of the technical object also to be projected.

In addition, a camera for recording a camera image of the technical object, of an environment of the technical object and/or of an environment of the apparatus can be provided.

The camera image can be evaluated by an image processing module coupled with the camera.

In particular, the image processing module can be coupled with the alignment module and can be set up to detect the alignment of the object structure projected onto the technical object with the corresponding surface structure of the technical object based on the camera image.

This allows an automatic detection of the correct alignment of the projection.

Furthermore, the image processing module can be coupled with the identification module and the identification module can be set up to identify the technical object based on the camera image. In this way, for example, a marking applied to the technical object, such as a QR code marking, can be recorded by the camera and from the camera image a QR code identifying the technical object can be extracted.

According to an advantageous further development of embodiments of the invention, the projection module and the image generation module can be set up to project so-called structured light onto the technical object. The image processing module can then be set up to determine a position, an orientation and/or a shape of a projection surface of the technical object from a camera image of the projected structured light.

The evaluation of camera images of projected structured light normally allows a relatively accurate spatial measurement of the technical object.

According to a further embodiment of the invention, a position detection module can be provided, for detecting a position and/or orientation of the technical object relative to the apparatus. The image generation module can then produce the structure image depending on the detected position and/or orientation of the technical object.

In particular, the position detection module can be coupled with the image processing module and be set up to detect the position and/or orientation of the technical object based on the camera image.

Furthermore the position detection module can comprise a motion sensor, acceleration sensor, position sensor, orientation sensor and/or satellite navigation receiver for detecting a motion, location, orientation and/or position of the apparatus. The image generation module can then be set up to update the structure image after detecting an alignment of the object structure projected onto the technical object with a corresponding surface structure of the technical object, in accordance with the detected motion, location, orientation and/or position of the apparatus. In particular, the image processing module in this case can detect the motion of the apparatus by determining an optical flow on the basis of one or a plurality camera images.

By the position detection module, the orientation, scaling, and an image excerpt to be projected of the structure image can be defined and/or updated, depending on the detected position and/or orientation of the technical object.

### BRIEF DESCRIPTION

Some of the embodiments will be described in detail, with reference to the following figures, wherein like designations denote like members, wherein:

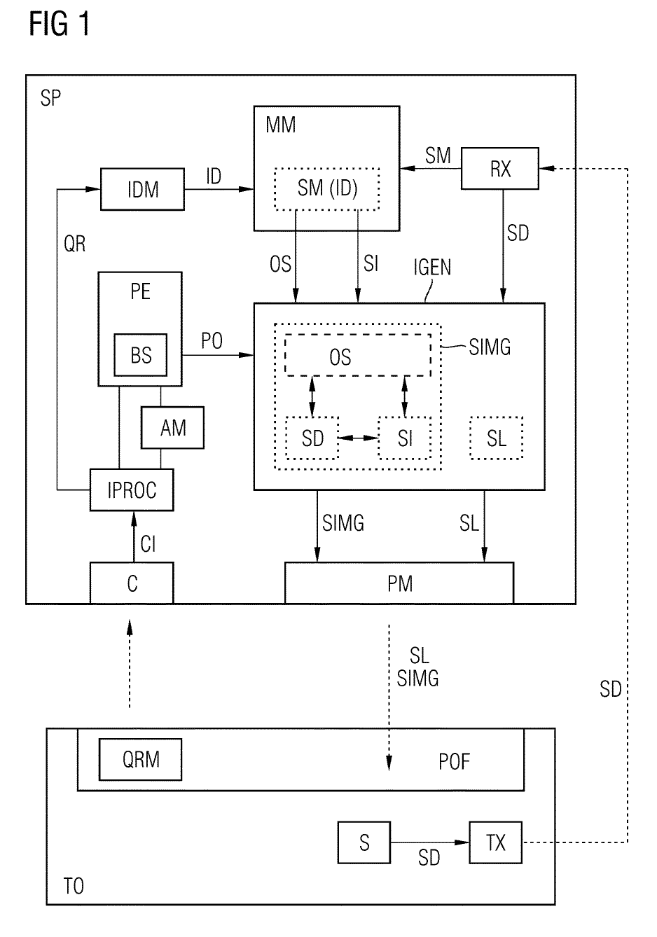

FIG. 1 a technical object and a mobile device for presenting structure information about this technical object;

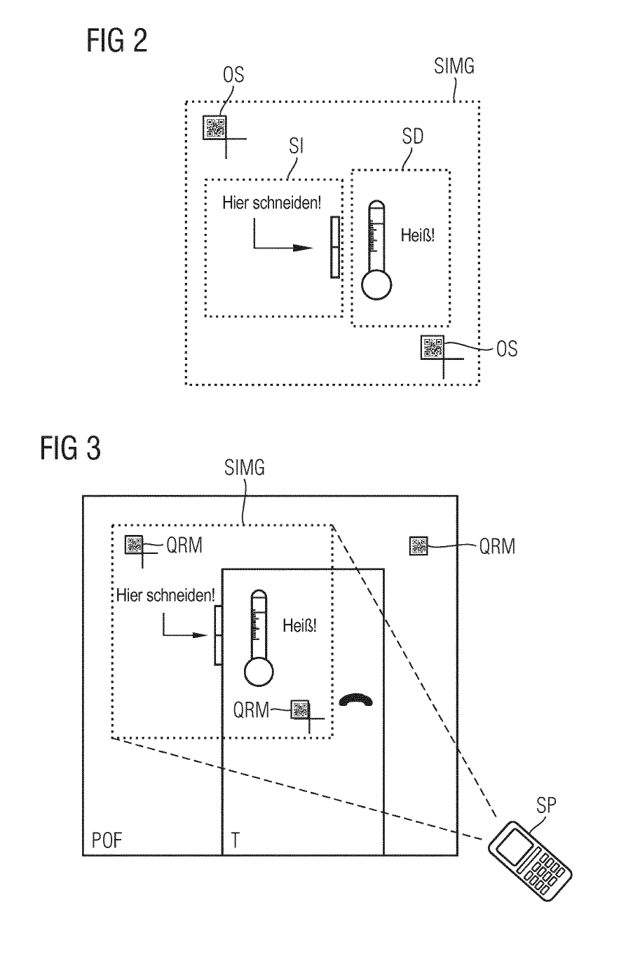

FIG. 2 a structure image of the technical object generated by the mobile device;

FIG. 3 a projection of the structure image onto the technical object; and

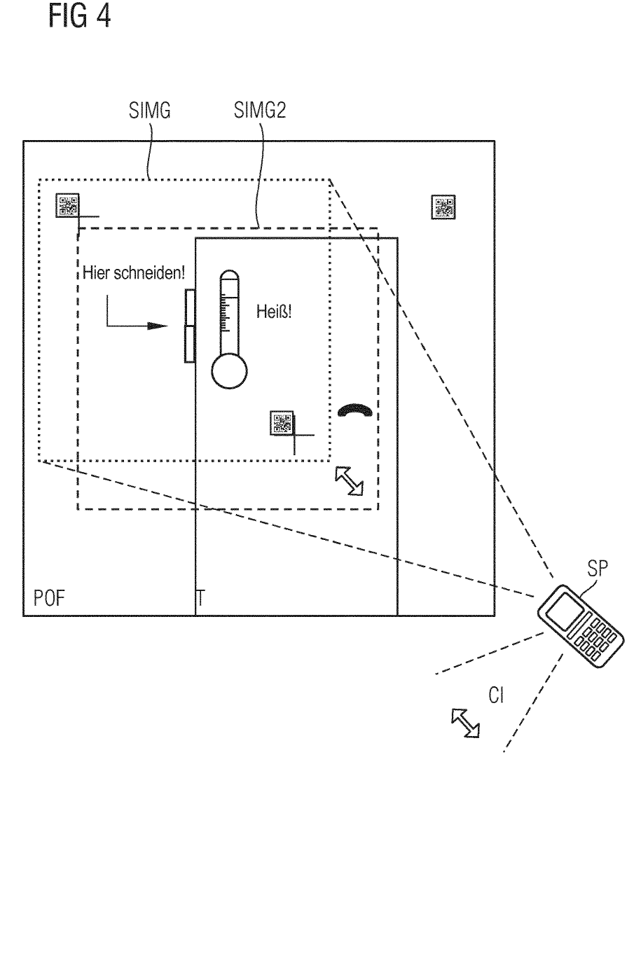

FIG. 4 an illustration of an updating of this projection while the mobile device is being moved.

### DETAILED DESCRIPTION

FIG. 1 shows an apparatus SP according to embodiments of the invention, implemented as a mobile device, for presenting structure information about a technical object TO and also this technical object TO itself, represented schematically.

The technical object TO can be, for example, a vehicle, an airplane, a building, a machine, a device, a circuit or a system. It preferably includes a sensor S for detecting sensor data SD as status information about the technical object TO. The sensor data SD can relate e.g. to temperature, pressure, filling level or other dynamic parameters of the technical object TO or particular spatially bounded regions of the same. The sensor data SD are detected by sensor S, preferably in real time.

The technical object TO further comprises a transmitter TX for sending the sensor data SD, preferably wirelessly, e.g. via a so-called Bluetooth interface. Alternatively or additionally, the transmitter TX can also be set up to send the sensor data SD via one or more wired interfaces. In particular, a plurality of interfaces, positioned differently on the technical object TO, can be provided, which transmit different sensor data. In this way, by selection of the interface to which the mobile device SP is coupled, a user can restrict the sensor data to be transmitted.

An outer surface of the technical object TO is used as a projection surface POF for a projection of a structure image onto the technical object TO by means of the mobile device SP according to embodiments of the invention. On the projection surface POF there are located externally, preferably visually, recognizable object characteristics QRM of the technical object TO. In the present exemplary embodiment markings applied to the technical object TO, e.g. so called QR-code markings QRM, are provided as externally recognizable object characteristics. Such QR-code markings QRM may at the same time advantageously serve to identify the technical object TO.

The mobile device SP according to embodiments of the invention comprises a projection module PM, e.g. an LED projector or a projection device having one or more deflected laser beams. As the mobile device SP, a smartphone equipped with an LED projector, for example, can be used.

The mobile device SP further includes a position detection module PE for detecting a position and/or orientation PO of the technical object TO relative to the mobile device SP. The position detection module PE comprises in turn a motion sensor, acceleration sensor, location sensor, orientation sensor, satellite navigation receiver and/or a different position sensor BS for detecting a motion, location, orientation and/or position of the mobile device SP. Such position sensors BS can be implemented, e.g., by means of a gyroscope, Hall effect sensor or a compass.

The mobile device SP also comprises a camera C for recording a camera image CI of the technical object TO, of an environment of the technical object TO and/or of an environment of the mobile device SP. The camera C can be suitable for recording camera images CI in visible light, in infrared light and/or in ultra-violet light. Instead of or in addition to the camera, a 3D scanner can also be provided for scanning the technical object TO, the environment of the technical object TO and/or the environment of the mobile device SP. This allows scanned 3D shapes to be used instead of or in addition to the camera image CI.

The mobile device SP further comprises an image processing module IPROC coupled with the camera C and the position detection module PE, for evaluating the camera image CI. This allows the position detection module PE to detect the relative position and/or orientation PO of the technical object TO and of the mobile device SP relative to each other, on the basis of the camera image CI of the technical object TO evaluated by the image processing module IPROC, the environment of the technical object TO and/or the environment of the mobile device SP.

It can preferably be provided that so-called structured light SL is projected onto the technical object TO by means of the projection module PM. On the basis of a camera image of the structured light SL projected onto the projection surface POF, the relative position and/or orientation PO and a shape of the projection surface POF can be determined. The relative position and/or orientation PO is transmitted by the position detection module PE to an image generation module IGEN.

The mobile device SP further comprises an identification module IDM for identifying the technical object TO, preferably based on a camera image CI of the technical object TO. In the present exemplary embodiment, the image processing module IPROC detects the QR-code markings QRM applied to the technical object TO in the camera image CI and extracts a data content, i.e. a QR-code QR of the QR-code markings QRM, and transmits it to the identification module IDM. From this, the identification module IDM determines a unique object identifier ID of the technical object TO and/or a region of the technical object TO which is assigned to the respective QR-code marking. Alternatively or in addition, other object characteristics of the technical object TO can also be detected based on the camera image CI and used for identification. If the camera C is sensitive to infrared or ultraviolet light, then markings which are invisible to human beings can also be applied to the technical object and evaluated by the image processing module IPROC.

Alternatively or in addition to the automatic identification of the technical object TO based on the object characteristics QRM, it can also be provided that the technical object is identified based on a user input, e.g. of a vehicle type or a room number.

According to embodiments of the invention the mobile part SP includes a modeling module MM, which provides a preferably three-dimensional structure model SM of the identified technical object TO. The structure model SM of the technical object TO can be received by the modeling module MINI, e.g. by means of a receiver module RX, and processed. The receiver module RX can receive the structure model SM for example via mobile radio, WLAN and/or Bluetooth or via a wired interface.

The structure model SM is used to present an externally recognizable object structure OS of the technical object TO and also internal structure information SI about the technical object. The structure model SM contains the object structure OS and the structure information SI in a spatial association to each other that corresponds to the actual technical object TO. In particular, the structure information SI is represented in its relative position to the object characteristics QRM. The object structure OS corresponds to externally visible surface structures of the technical object, preferably to a plurality of visually easily identifiable static object characteristics or object markings of the technical object TO. These can be, e.g., door edges, door corners, door plates etc., in each case in a positionally faithful spatial association to other object characteristics of the technical object TO. In the present exemplary embodiment the QR-code markings QRM, in particular, are used for this purpose. To this end the QR-code markings QRM and their respective position on the technical object TO are stored in the structure model SM.

The structure information SI reproduces internal structures, preferably structures of the technical object TO that are not externally recognizable, or only with difficulty. This can be, for example, a pattern of cables or other technical structures concealed underneath the object surface. These are represented by the structure model SM in their spatial association to the externally recognizable object structure OS.

On the basis of the identified structure model SM the modeling module MINI determines the object structure OS and the structure information SI and transmits these to the image generation module IGEN. In addition, the receiver module RX receives the sensor data SD wirelessly from the transmitter TX of the technical object TO and also transmits the sensor data SD to the image generation module IGEN. The structure model SM preferably contains a piece of information about a relative position of the sensor S in the technical object TO, so that the modeling module MM can spatially position the sensor data SD relative to the object structure OS and the structure information SI and it also transmits this positioning to the image generation module IGEN.

The image generation module IGEN is used for generating a structure image SIMG and for generating the structured light SL. The image generation module IGEN inserts the object structure OS, the structure information SI and the sensor data SD, which are spatially associated to each other, into the structure image SIMG, in each case in appropriate graphical assignment in a manner true to projection. In the process, the structure information SI and the sensor data SD are inserted in a mode of presentation that differs from the mode of presentation of the object structure OS. The modes of presentation can differ, for example, with regard to their color, brightness, their contrast, etc. The graphical association within the structure image SIMG is illustrated in FIG. 1 by double arrows. The image generation module IGEN defines an orientation, scaling, perspective and/or a displayed image section of the structure image SIMG according to the relative position and/or orientation PO and according to the shape of the projection surface POF. This is effected in such a way that when projected onto the technical object TO, a content of the structure image SIMG can be brought into alignment with a corresponding surface structure of the technical object TO. The incorporation of the shape of the surface allows the projected structure image SIMG to be rectified in such a way that the object structures to be displayed are reproduced to scale.

The structure image SIMG generated is transmitted by the image production module IGEN to the projection module PM, which projects it onto the projection surface POF of the technical object TO.

The projection of the object structure OS is brought into alignment with the corresponding object characteristics, here QRM, manually and/or automatically. If the projection and the actual object characteristics QRM are coextensive, the projection is aligned. In order to detect a completed alignment, an orientation module AM is provided. The alignment module AM is coupled to the image processing module IPROC and with the position detection module PE. The detection of the alignment can be performed automatically on the basis of the camera image CI of the technical object TO and/or manually by activating a switch or push-button. Such a detection of the correct alignment is often also referred to as registration.

FIG. 2 shows a more detailed schematic representation of the generated structure image SIMG. As an externally recognizable object structure OS of the technical object TO, images of the QR-code markings QRM are inserted according to their position in relation to each other and to other externally recognizable object structures, and corresponding to externally visible object characteristics or object markings of the technical object TO. The images of the QR-code markings QRM are augmented in a form-fitting manner with cross-hairs, which act as projection structures that facilitate the alignment.

As structure information SI an outwardly invisible hinge is inserted into the structure image SIMG at its correct position relative to the QR-code markings QRM. In addition, a short caption “Cut here!” is included with a corresponding arrow. Furthermore, as status information SD, an image of a thermometer illustrating a temperature in the vicinity of the hinge is inserted into the structure image SIMG together with a short caption “Hot!”. The structure information SI and the status information SD are displayed e.g. in a different color than the object structures OS.

FIG. 3 shows a projection of the structure image SIMG onto the projection surface POF of the technical object TO. As an example, the projection surface POF is assumed to be a wall of a building or of an aircraft with a door T, e.g. a door to a machine room. The wall has, for example, three applied QR-code markings QRM, two of which lie in a projection cone of the mobile device SP implied by a dotted line. On the basis of the QR-code markings QRM, the structure model SM, or the resulting structural image SIMG, can be aligned to the real technical object TO. Moreover, the applied QR-code markings QRM allow the unique identification of the technical object TO and of the spatial region around any detected QR-code marking QRM.

The QR-code can be simply read in by means of the camera CI of the mobile device SP. On the basis of the camera image CI, the relative position and/or orientation PO of the QR-code markings QRM and the mobile device SP with respect to each other can also be determined. On the basis of the determined position and/or orientation PO, the structures OS, SI and SD relevant to the projection can be generated from the structure model SM.

This process can take into account distortions that result from the shape of the projection surface POF, which is stored in the structure model SM and/or detected by means of the structured light SL. The structure image SIMG created in this way is projected by the projection module PM onto the projection surface POF and brought into alignment with the corresponding surface structure, here the applied QR-code markings QRM. The cross-hairs projected along with the image facilitate the correct alignment.

Alternatively or in addition to the alignment to the markings QRM, other externally recognizable object structures OS of the technical object TO can also be projected. In the present case of a door T located on the projection surface POF, e.g. an externally visible door frame or a door plate can be projected as an object structure OS and brought into alignment with the real door frame or door plate of the technical object TO.

The alignment of the projected structure image SIMG can be performed manually by the user or else automatically, based on the relative position and/or orientation PO that has been determined. In the latter case, the structure image SIMG is generated depending on the relative position and/or orientation PO in such a way that its projection is aligned to the corresponding surface structure of the technical object TO. A completed alignment is then detected by means of the alignment module AM.

The projection indicates directly and intuitively to the user of the mobile device SP where an externally invisible hinge is concealed, and what should be done with it in an emergency. It also indicates that the temperature in the area of the hinge is very high.

Embodiments of the invention have a wide range of applications in rescue, maintenance and/or repairs. By the optically directly visible superposition of the structure model SM on the real technical object TO, e.g. an ideal starting point for a drill hole or other technical measure can be directly represented. An error-prone transmission from a presentation medium onto the actual technical object can thus be avoided in many situations.

After the completed alignment, or registration, of the projection, this can be automatically tracked during movement of the mobile device SP.

FIG. 4 illustrates such a tracking. This tracking is based on the detection of a movement, location, orientation and/or position of the mobile device SP after successful registration. The detection is performed by means of the position sensor BS and/or based on an optical flow, which is determined by evaluation of one or more camera images CI. Based on the detected motion, location, orientation and/or position, the relative orientation of the mobile device SP to the projection surface POF is calculated in real time and a correspondingly updated structure image SIMG2 is generated.

It is assumed that after registration of the projection of the structure image SIMG, the mobile device SP moves as indicated by a double arrow. The extent and direction of the movement is detected based on the optical flow of a plurality of camera images CI and the position of the object structure OS, of the structure information SI and of the sensor data SD within the structure image SIMG is displaced in accordance with the detected motion—as indicated by a double arrow. In this manner, a new updated structure image SIMG2 is generated and projected in real-time that is at least approximately aligned with the object characteristics of the technical object TO. In addition, a fine-tuning can be performed on the basis of a camera image CI of the projected structure image SIMG2 by the alignment module AM.

In this manner, after an initial registration of the projection, relative movements of the mobile device SP can be automatically incorporated into the projection and compensated, so that the user can move the projection along the projection surface POF while maintaining an alignment. This facilitates in particular a hands-free operation without manual adjustments.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. An apparatus for presenting structure information about a technical object, having
(a) an identification module (IDM) for identifying the technical object,
(b) a modeling module
to provide a structure model of the identified technical object and
to specifically determine, in each case, an externally recognizable object structure for the technical object and a piece of internal structure information, which is physically associated with the object structure, about the technical object on the basis of the structure model and
(c) an image generation module (IGEN)
for creating a structure image of the technical object,
for inserting the object structure into the structure image in a manner true to projection and
for inserting the structure information into the structure image in a graphical association with the object structure in a mode of presentation that differs from the mode of presentation of the object structure, and
(d) a projection module for projecting the structure image onto the technical object.

2. The apparatus as claimed in claim 1, wherein an alignment module for detecting whether the object structure projected onto the technical object is coextensive with a corresponding surface structure of the technical object.

3. The apparatus as claimed in claim 1, wherein the modeling module is set up to determine a projection surface of the technical object on the basis of the structure model, and that the image generation module is set up to generate the structure image depending on a shape of the determined projection surface, in such a way that when projected onto the technical object, the projected object structure can be brought into alignment with a corresponding surface structure of the technical object.

4. The apparatus as claimed in claim 1, wherein a receiver module is provided for receiving status information about a status, which is physically associated with the object structure, of the technical object, and the image generation module is set up for inserting the status information into the structure image in a graphical association with the object structure.

5. The apparatus as claimed in claim 4, wherein the status information comprises sensor data from a sensor of the technical object.

6. The apparatus as claimed in claim 1, wherein a camera for recording a camera image of the technical object, of an environment of the technical object and/or of an environment of the apparatus, and an image processing module coupled with the camera for evaluating the camera image.

7. The apparatus as claimed in claim 2, wherein the alignment module is coupled with the image processing module, and the image processing module is set up to detect the alignment of the object structure projected onto the technical object with the corresponding surface structure of the technical object based on the camera image.

8. The apparatus as claimed in claim 6, wherein the identification module is coupled with the image processing module, and is set up to identify the technical object based on the camera image.

9. The apparatus as claimed in claim 6, wherein the projection module and the image generation module are set up to project structured onto the technical object, and the image processing module is set up to determine a position, an orientation and/or a shape of a projection surface of the technical object from a camera image of the projected structured light.

10. The apparatus as claimed in claim 1, wherein a position detection module is provided, for detecting a position and/or orientation of the technical object relative to the apparatus, and the image generation module is set up to produce the structure image depending on the detected position and/or orientation of the technical object.

11. The apparatus as claimed in claim 6, wherein the position detection module is coupled with the image processing module and is set up to detect the position and/or orientation of the technical object based on the camera image.

12. The apparatus as claimed in claim 10, wherein the position detection module comprises a motion sensor, acceleration sensor, position sensor, orientation sensor and/or satellite navigation receiver for detecting a motion, location, orientation and/or position of the apparatus, and the image generation module is set up to update the structure image after detecting an alignment of the object structure projected onto the technical object with a corresponding surface structure of the technical object, in accordance with the detected motion, location, orientation and/or position of the apparatus.

13. The apparatus as claimed in claim 6, wherein the image processing module is set up to detect the motion of the apparatus by determining an optical flow on the basis of one or a plurality of camera images.

14. A method for presenting structure information about a technical object, wherein
(a) the technical object is identified,
(b) a structure model of the identified technical object is provided,
(c) on the basis of the structure model
an externally recognizable object structure of the technical object and
a piece of internal structure information, which is physically associated with the object structure, about the technical object
are specifically determined in each case,
(d) a structure image of the technical object is produced, wherein
the object structure is inserted into the structure image in a manner true to projection, and
the structure information is inserted into the structure image in graphical association with the object structure in a mode of presentation that differs from the mode of presentation of the object structure, and
e) the structure image is projected in such a way that when projected onto the technical object, the projected object structure can be brought into alignment with a corresponding surface structure of the technical object.

15. A computer program product for presenting structure information about a technical object that is set up for executing a method, comprising a computer readable hardware storage device having computer readable program code stored therein, said program code executable by a processor of a computer system to implement a method as claimed in claim 14.
